(19) United States
(12) Patent Application Publication
(10) Pub. No.: US 2025/0274151 A1
(43) Pub. Date: Aug. 28, 2025

(54) ANTENNA DEVICE AND ELECTRONIC APPARATUS USING THE SAME

(71) Applicant: Universal Global Technology (Kunshan) Co.,Ltd, KUNSHAN (CN)

(72) Inventors: JUI-CHIH CHIEN, KUNSHAN (CN); CHANG-WEI LIN, KUNSHAN (CN); YANG-KAI CHOU, KUNSHAN (CN); YONG-TING LEE, KUNSHAN (CN); CHIH-SEN HSIEH, KUNSHAN (CN)

(21) Appl. No.: 18/964,882

(22) Filed: Dec. 2, 2024

(30) Foreign Application Priority Data
Feb. 26, 2024 (CN) 202410208378.4

(51) Int. Cl. H04B 1/10; H01Q 9/04

(52) U.S. Cl. CPC H04B 1/1018; H01Q 9/0414

(57) ABSTRACT

An antenna device and an electronic apparatus are provided. An antenna device includes an antenna structure and a noise suppression part. The noise suppression part is disposed at one side of the antenna structure. The noise suppression part and the antenna structure have a predetermined distance therebetween. The noise suppression part is connected to the antenna structure through a common grounding part. The noise suppression part and the antenna structure are separately disposed.

### CROSS-REFERENCE TO RELATED PATENT APPLICATION

This application claims the benefit of priority to China Patent Application No.: 202410208378.4, filed on Feb. 26, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an antenna device and an electronic apparatus, and more particularly to an antenna device with a noise suppression part and an electronic apparatus using the same.

### BACKGROUND OF THE DISCLOSURE

With the development of communication systems, more and more antennas are required in mobile communication devices, and it becomes increasingly difficult to design antennas in a limited space.

In mobile communication devices, some antenna devices are usually located very close to various circuits, buttons (such as power buttons) or lens modules in the surrounding environment. In addition, since the bandwidth of each antenna is quite wide, it is easy to produce a lot of anti-radiation interference from metal around the antenna. Correspondingly, the interference will also cause a reduction in antenna efficiency. For example, antenna reflection coefficients can easily have many more resonant frequency bands, which will affect the antenna radiation energy.

Therefore, in the harsh metal environment of mobile communication devices, it has become an important issue in this field to remove additional radiation energy so that the antenna device can reduce the influence from the surrounding environment and restore the original characteristics of the antenna device.

### SUMMARY OF THE DISCLOSURE

In response to the above-referenced technical inadequacies, the present disclosure provides an antenna device.

In order to solve the above-mentioned problems, one of the technical aspects adopted by the present disclosure is to provide an antenna device. The antenna device includes an antenna structure and a noise suppression part. The noise suppression part is disposed at one side of the antenna structure. The noise suppression part and the antenna structure have a predetermined distance therebetween. The noise suppression part is connected to the antenna structure through a common grounding part. The noise suppression part and the antenna structure are separately disposed.

In order to solve the above-mentioned problems, another one of the technical aspects adopted by the present disclosure is to provide an electronic apparatus. The electronic apparatus includes a housing, a circuit board and an antenna device. The circuit board is disposed in the housing. The antenna device is disposed on the housing or the circuit board. The antenna device includes an antenna structure and a noise suppression part. The noise suppression part is disposed at one side of the antenna structure. The noise suppression part and the antenna structure have a predetermined distance therebetween. The noise suppression part is connected to the antenna structure through a common grounding part. The noise suppression part and the antenna structure are separately disposed.

Therefore, the antenna device and the electronic apparatus provided by the present disclosure have a simple structure and can be easily designed, and the antenna structure of the present disclosure can eliminate unnecessary resonance noises to improve antenna performance, and is manufactured using a laser direct forming process, which can effectively reduce working hours and costs.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an antenna device according to a first embodiment of the present disclosure;

FIG. 2 is a chart of reflection loss/frequency performance of the antenna device without a noise suppression part and the antenna device with a noise suppression part of the first embodiment;

FIG. 3 is a schematic view of antenna efficiency of the antenna device according to the first embodiment of the present disclosure;

FIG. 4 is a schematic view of an antenna device according to a second embodiment of the present disclosure;

FIG. 5 is a schematic view of an antenna device according to the second embodiment of the present disclosure;

FIG. 6 is a chart of reflection loss/frequency performance of the antenna device with a noise suppression part of the second embodiment;

FIG. 7 is a schematic view of an antenna device according to a third embodiment of the present disclosure;

FIG. 8 is a chart of reflection loss/frequency performance of the antenna device without a noise suppression part and the antenna device with a noise suppression part of the third embodiment; and

FIG. 9 is a schematic view of an electronic apparatus according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

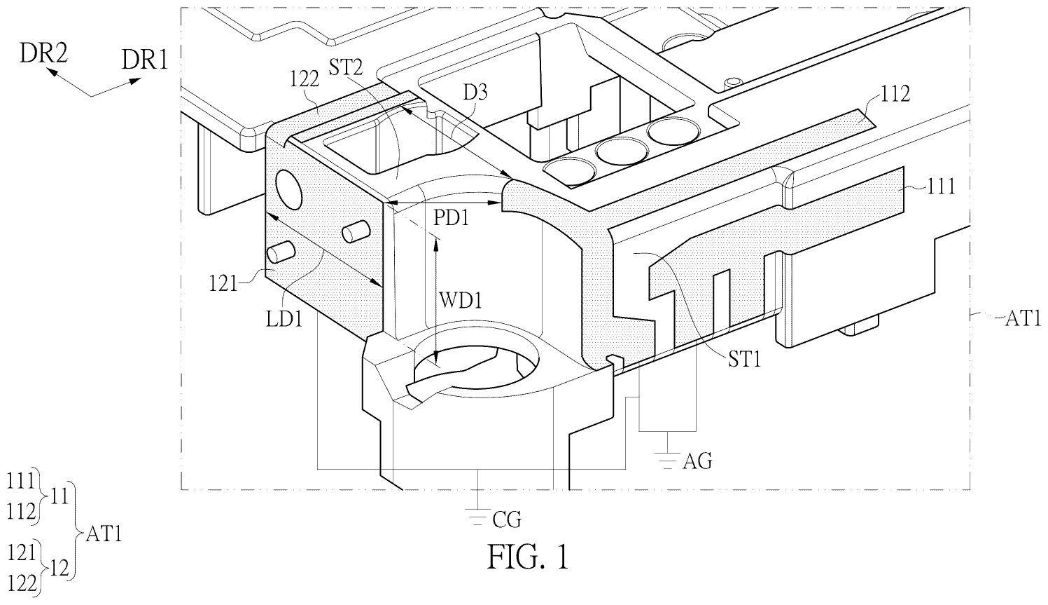

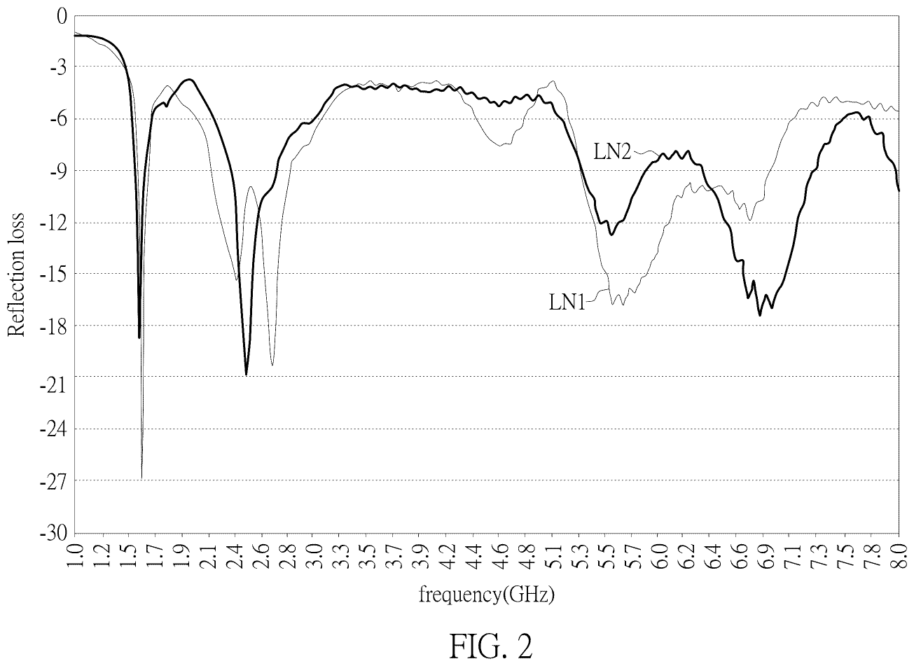

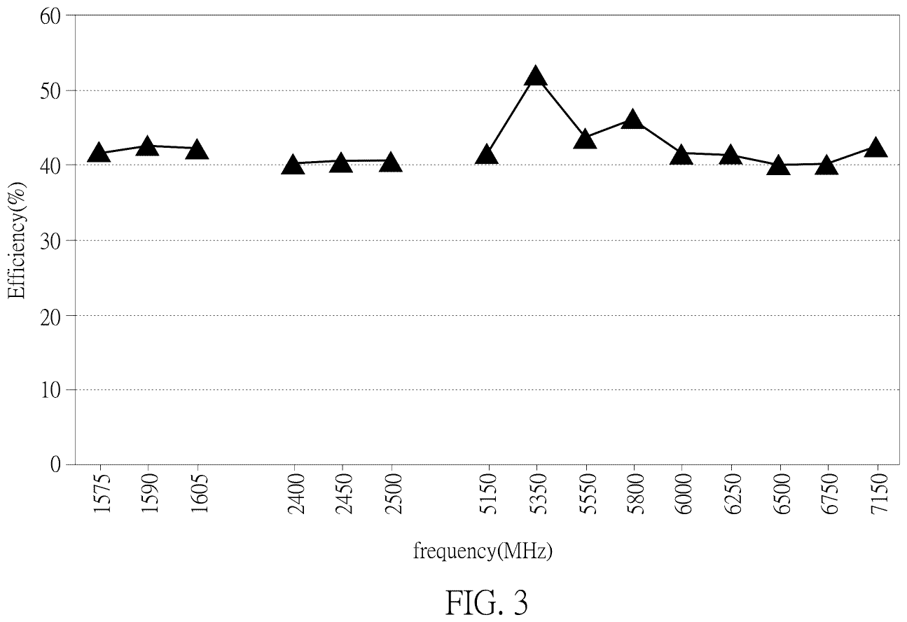

Referring to FIG. 1, FIG. 2, and FIG. 3, FIG. 1 is a schematic view of an antenna device according to a first embodiment of the present disclosure. FIG. 2 is a chart of reflection loss/frequency performance of the antenna device without a noise suppression part and the antenna device with a noise suppression part of the first embodiment. FIG. 3 is a schematic view of antenna efficiency of the antenna device according to the first embodiment of the present disclosure.

In this embodiment, an antenna device AT1 is provided. The antenna device AT1 includes an antenna structure 11 and a noise reduction part 12.

In this embodiment, the antenna structure 11 is disposed at a first substrate ST1. The noise reduction part 12 is disposed at a second substrate ST2.

In this embodiment, the first substrate ST1 and the second substrate ST2 are adjacent and connected to each other. That is, although the first substrate ST1 and the second substrate ST2 are disposed on adjacent curved surfaces, they are not arranged on a plane. That is, the noise suppression part 12 is provided on one side of the antenna structure 11. Moreover, the noise suppression part 12 and the antenna structure 11 have a predetermined distance PD1 therebetween.

In addition, the noise suppression part 12 and the antenna structure 11 are disposed independently. The noise suppression part 12 and the antenna structure 11 are connected through a common grounding part CG. That is, the noise suppression part 12 is provided separately and is connected to the antenna structure 11 through a connection path with the common grounding part CG.

As shown in FIG. 1, in this embodiment, the antenna structure 11 and the noise suppression part 12 are disposed on two sides of a power button of an electronic apparatus (not shown). The antenna structure 11 and the noise suppression part 12 are connected to each other through the grounding part of the power button.

In other embodiments, the antenna structure 11 and the noise suppression part 12 are connected to each other through the grounding part of other circuits.

Furthermore, the antenna structure 11 is a multi-band antenna. That is, in this embodiment, the antenna structure 11 at least includes a first antenna structure 111 and a second antenna structure 112. The first antenna structure 111 is disposed on one side of the second antenna structure 112. In this embodiment, the first antenna structure 111 is an inverted F antenna (PIFA). The first antenna structure 111 and the second antenna structure 112 together form a Couple-PIFA antenna. That is, the antenna structure 11 may include multiple frequency bands. In other embodiments, the antenna structure 11 may be other different antenna structures in addition to the inverted F antenna 111. Furthermore, the first antenna structure 111 and the second antenna structure 112 include a ground portion AG, and the first antenna structure 111 and the second antenna structure 112 are connected to the ground portion AG. In this embodiment, various noises exist in the environment where the antenna structure 11 is located. Therefore, a noise suppression part 12 is provided adjacent to the antenna structure 11 and connected through a common grounding part CG. That is, the noise suppression part 12 is a structure independent of the antenna structure 11. In this embodiment, the noise suppression part 12 and the antenna structure 11 may be jointly connected to a common ground potential that is the ground potential of a power button (not shown) of the electronic apparatus (not shown) where the antenna device AT1 is located. In other embodiments, the noise suppression part 12 and the antenna structure 11 may be jointly connected to the grounding part of other circuits.

Furthermore, as shown in FIG. 1, the antenna structure 11 and the noise suppression part 12 are respectively disposed on a curved surface structure. In other embodiments, the antenna structure 11 and the noise suppression part 12 can also be respectively disposed on a plane, and is not limited in the present disclosure.

The noise suppression part 12 includes a first suppression part 121 and a second suppression part 122. One terminal of the second suppression part 122 is connected to the first suppression part 121. One terminal of the first suppression part 121 and one side of the antenna structure 11 have a predetermined distance PD1 therebetween. As shown in FIG. 1, the closest distance between the one terminal of the first suppression part 121 and the antenna structure 11 through the common ground part CG is the predetermined distance PD1. As shown in FIG. 1, the first suppression part 121 and the second suppression part 122 are respectively provided on two planes. In addition, there is an angle between the first suppression part 121 and the second suppression part 122.

That is, as shown in FIG. 1, the first suppression part 121 is disposed on a flat surface or a curved surface, and the second suppression part 122 is disposed on another flat surface or a curved surface, and there is an angle between the two structural surfaces. This angle is close to 90 degrees. That is, the first suppression part 121 and the second suppression part 122 are disposed in an L-shaped arrangement. In other embodiments, the first suppression part 121 and the second suppression part 122 may also be disposed on the same plane or the same curved surface.

A first extension length value LD1 and a first extension width value WD1 of the first suppression part 121 are respectively 8.2 mm. That is, the first suppression part 121 has a square shape. In other embodiments, the first extension length value LD1 and the first extension width value WD1 of the first suppression part 111 can be designed according to practical requirements, and are not limited in the present disclosure.

In this embodiment, the length (current path length) of the noise suppression part 12 is a quarter wavelength of the Global Positioning System antenna (GPS) to match to the antenna structure 11 (the first antenna structure 111 and the second antenna structure 112) that can effectively suppress environmental noise. Furthermore, the length values of the first suppression part 121 and the second suppression part 122 can be adjusted according to practical requirements, and are not limited in the present disclosure. The predetermined distance is 5 mm, and a distance D3 between one terminal of the second suppression part 122 and the antenna structure 11 is 6 mm.

In FIG. 1, the antenna structure 11 and the noise suppression part 12 are disposed on different planes. In other embodiments, the antenna structure 11 and the noise suppression part 12 may be disposed on the same plane and adjacent to each other.

Referring to FIG. 2, In FIG. 2, the curve LNI is the reflection loss/frequency performance of an antenna device without a noise suppression part. A curve LN2 is the reflection loss/frequency performance of an antenna device having a noise suppression part. In the curve LN2, the reflection loss at the 1.6 GHZ (1.575 GHZ), 2.4 GHZ˜2.7 GHZ, 5 GHZ˜7.1 GHz and other regions is excellent.

In this embodiment, the antenna structure 11 is a planar inverted F antenna (PIFA antenna). The feed end (not shown) and the ground end (not shown) of the antenna structure 11 are combined, and the length of the trench (or slot) is used to adjust the quarter resonance length of the current path, and then the common grounding part is CG is connected to another metal whose length is about a quarter of the wavelength of the GPS current path to couple with the PIFA antenna to produce multi-frequency resonance. The bandwidth of the original PIFA antenna (antenna structure 11) can cover the global positioning system (GPS) frequency band (1.575 GHz) and the dual frequency bands used by the WiFi_6E communication system: 2.4 GHz frequency band (2.4 GHz˜2.5 GHZ) and 5 GHz frequency band (5.15 GHZ˜7.15 GHZ). The antenna device AT1 of this embodiment is manufactured using a laser direct structuring process (LDS). The laser direct structuring process (LDS) mainly uses the operation of laser beams to directly shape the designed antenna on the surface of a three-dimensional substrate, which also makes the fabrication and production of antenna devices more efficient.

The antenna device AT1 of this embodiment can be designed in conjunction with the structure of the mobile device to increase the reception signal efficiency of the WiFi_6E mobile device (such as a mobile phone). In current mobile devices, multiple sets of antennas are usually installed, such as Wi-FiR antennas, Bluetooth antennas, Global Positioning System antennas (GPS) or 5G antennas. The design method of the antenna device AT1 in this embodiment (antenna structure 11 and the noise suppression part 12) can remove additional radiation noise in a harsh sealed environment, so that the broadband antenna can effectively perform the characteristics of the original antenna design.

The antenna device AT1 in this embodiment uses a laser direct forming process combined with metal components to integrate into the complex environment of electronic apparatus, and can suppress the parasitic resonance modes caused by the environment without increasing the size and cost of the electronic apparatus. The experimental results show that the reception effect of mobile phones can be restored and these interferences can be eliminated.

Referring to FIG. 3, the radiation efficiencies of the antenna device AT1 in each frequency band are above the standard specification.

### Second Embodiment

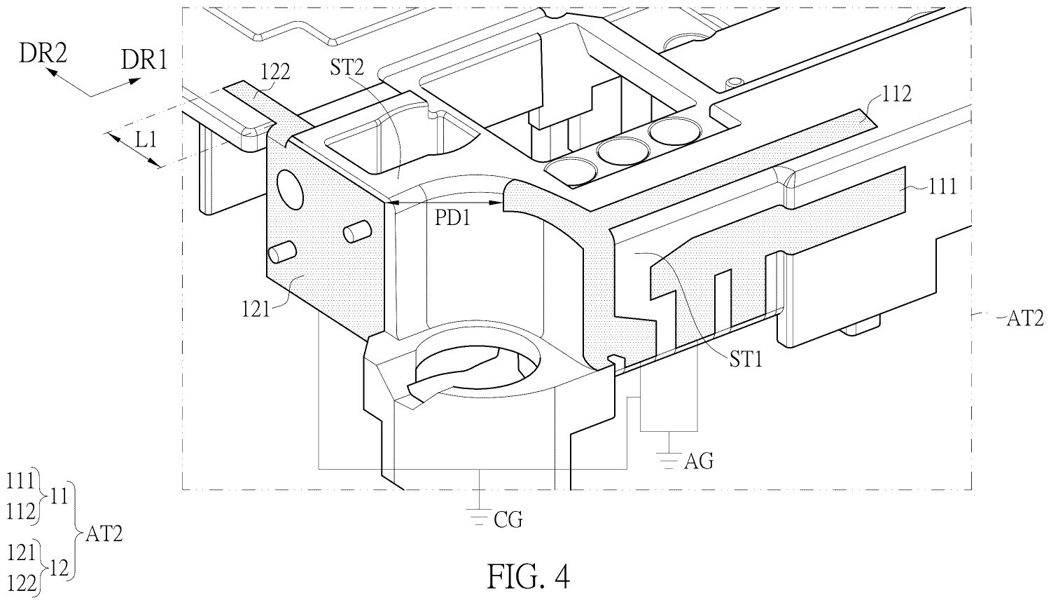

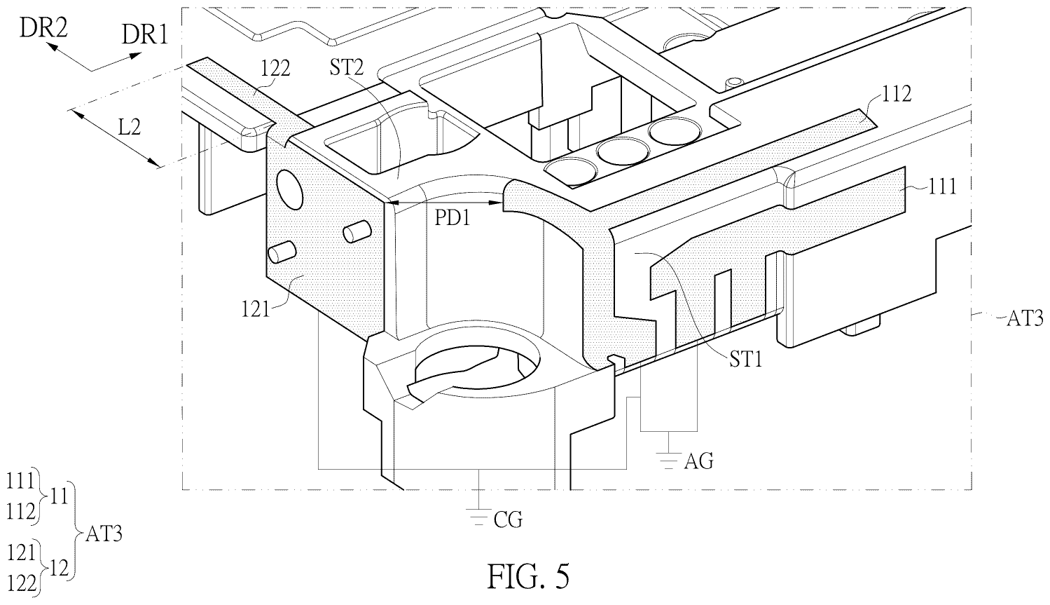

Referring to FIG. 4 and FIG. 5, FIG. 4 is a schematic view of an antenna device according to a second embodiment of the present disclosure. FIG. 5 is another schematic view of an antenna device according to a first embodiment of the present disclosure.

The antenna device AT2 of this embodiment is similar to the antenna device AT1 of the first embodiment. The main difference is that the second suppression part 122 of the noise suppression part 12 extends toward a second direction DR2. The second direction DR2 and the first direction DR1 are perpendicular to each other.

In this embodiment, each of the first suppression part 121 and the second suppression part 122 has a rectangular structure. A length value L1 of the second suppression part 122 is 5 mm.

However, similarly, the noise suppression part 12 and the antenna structure 11 at least have the predetermined distance PD1 therebetween. The predetermined distance PD1 is 5 mm.

Referring to FIG. 5, the antenna device AT3 is also similar to the antenna device AT1. The main difference of the antenna device AT3 and the antenna device AT1 is that the second suppression part 122 of the noise suppression part 12 extends toward the second direction DR2.

Moreover, each of the first suppression part 121 and the second suppression part 122 of the noise suppression part 12 in FIG. 5 is also a rectangular structure. The length value L2 of the second suppression part 122 of the noise suppression part 12C is 10 mm.

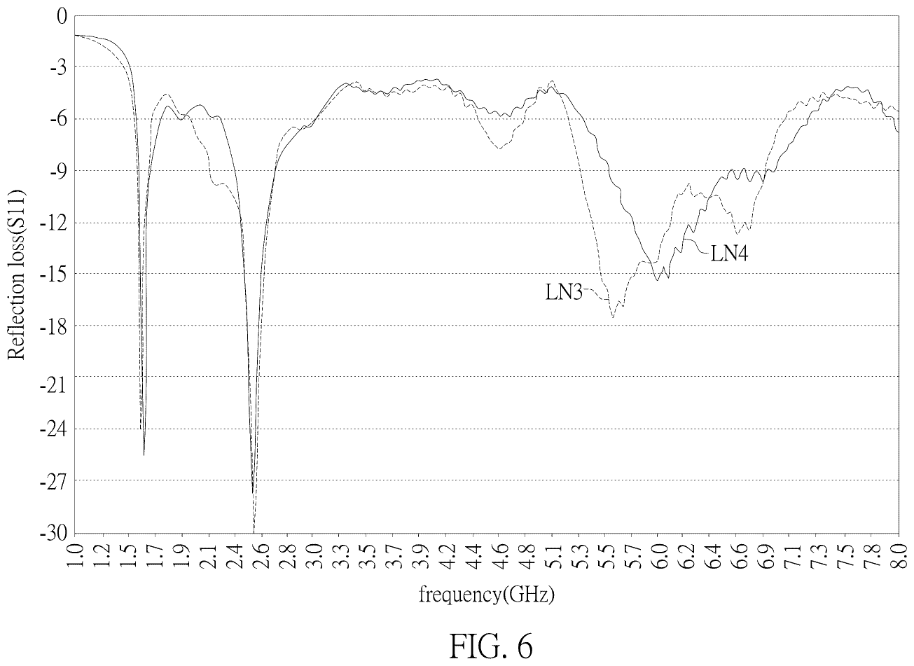

Referring to FIG. 6, FIG. 6 is a chart of reflection loss/frequency performance of the antenna device with a noise suppression part of the second embodiment of the present disclosure. A curve LN3 is the reflection loss/frequency performance of antenna device AT2. A curve LN4 is the reflection loss/frequency performance of the antenna device AT3. As shown in FIG. 6, the antenna device AT2 and the antenna device AT3 can have a certain effect on noise suppression.

### Third Embodiment

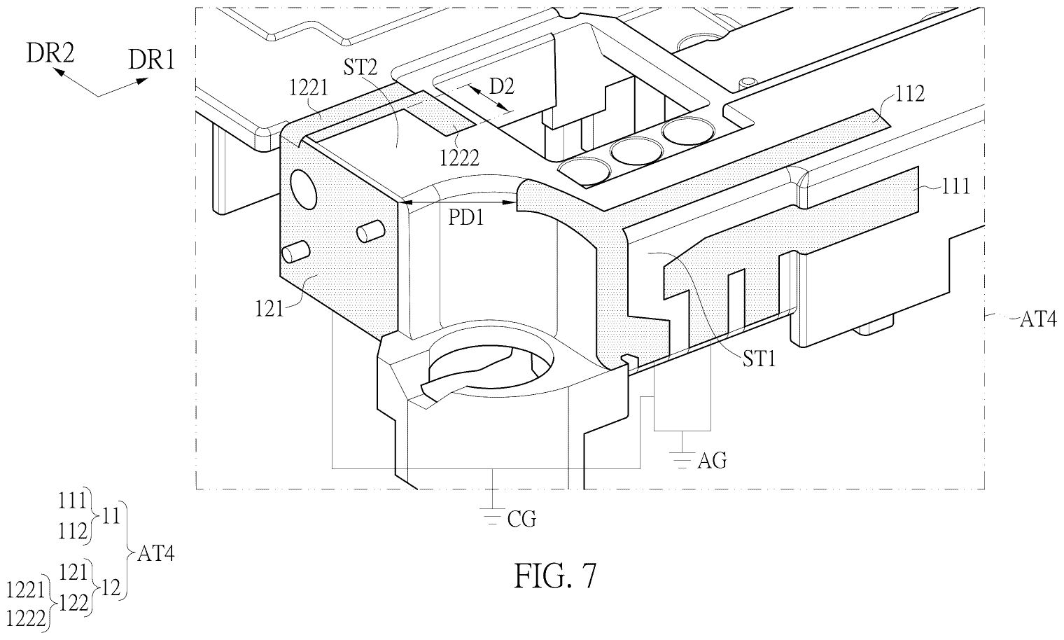

Referring to FIG. 7, FIG. 7 is a schematic view of an antenna device according to a third embodiment of the present disclosure.

An antenna device AT4 of FIG. 7 is similar to the antenna device AT1 of the first embodiment. The main difference between the antenna device AT4 and the antenna device AT1 is that the second suppression part 122 of the noise suppression part 12 of the antenna device AT4 has an L-shaped structure. The first suppression part 121 of the noise suppression part 12 of the antenna device AT4 also has a rectangular structure. The first suppression width of the first suppression part 121 is 8.2 mm. The first suppression length of the first suppression part 121 is also 8.2 mm.

Since the second suppression part 122 in this embodiment is an L-shaped structure, the second suppression part 122 includes a first length part 1221 and a second length part 1222. One terminal of the first length part 1221 is connected to the first suppression part 121. The other terminal of the first length part 1221 is connected to one terminal of the second length part 1222. The other terminal of the second length part 1222 is disposed toward the antenna structure 11. A length value of the first length part 1221 is 5 mm. A length value D2 of the second length part 1222 is 2 mm. However, similarly, the noise suppression part 12 and the antenna structure 11 at least have a predetermined distance PD1 therebetween. The predetermined distance PD1 is 5 mm.

In this embodiment, the total length of the second suppression part 122 is a sum of the length value of the first length part 1221 (5 mm) and the length value of the second length part 1222 (2 mm), that is, 7 mm. The total length is used for noise suppression at longer wavelengths.

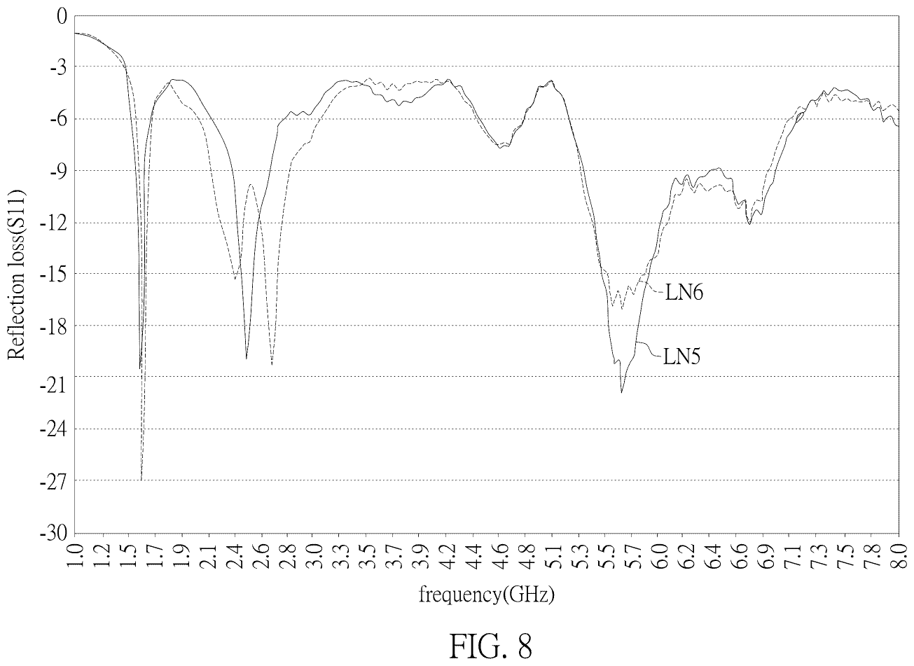

Referring to FIG. 8, FIG. 8 is a chart of reflection loss/frequency performance of the antenna device without a noise suppression part and the antenna device with a noise suppression part of the third embodiment.

A curve LN5 is the reflection loss/frequency performance of the antenna device AT4 in this embodiment. A curve LN6 is the reflection loss/frequency performance of the antenna device without the noise suppression part. As shown in FIG. 8, the configuration of the antenna device AT4 can also have a certain effect on noise suppression.

### Fourth Embodiment

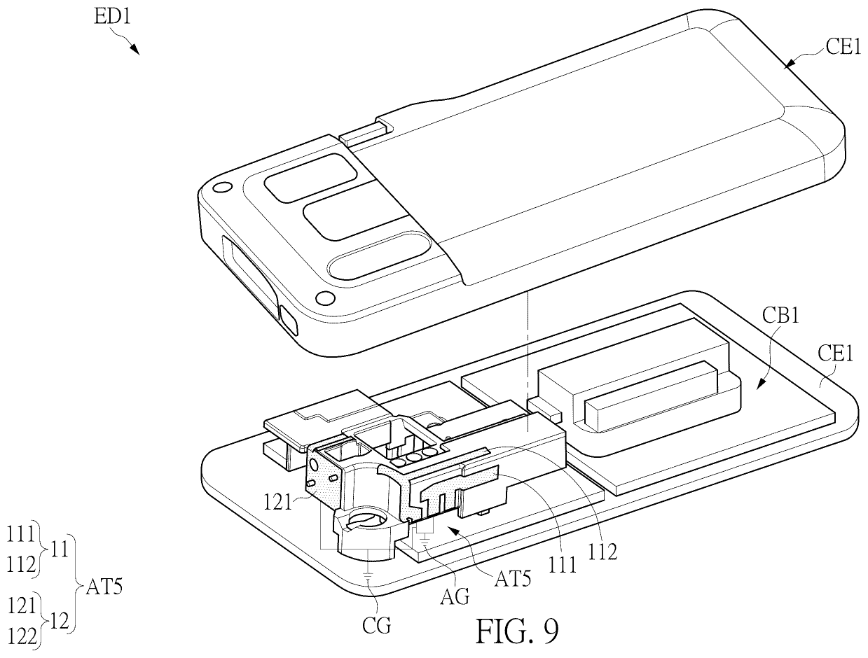

Referring to FIG. 9, FIG. 9 is a schematic view of an electronic apparatus according to a fourth embodiment of the present disclosure.

In this embodiment, an electronic apparatus ED1 is provided. The electronic apparatus ED1 at least includes a housing CE1, a circuit board CB1 and an antenna device AT5.

A ground portion AG of the antenna device AT5 is connected to a common grounding part CG on the circuit board CB1. The antenna device AT5 and the circuit board CB1 are arranged in the housing CE1.

The function and structure of the antenna device AT5 are similar to the antenna device AT1 of the first embodiment, the antenna devices AT2-AT3 of the second embodiment, and the antenna device AT4 of the third embodiment, and will be omitted in this embodiment.

However, the noise suppression part 12 and the antenna structure 11 of the antenna device AT5 of this embodiment are commonly connected to the common grounding part CG. The common grounding part CG is a ground potential disposed on the circuit board CB1.

Furthermore, the first suppression part 121 and the second suppression part 122 of the antenna device AT5 may be disposed on the housing CE1 or the circuit board CB1.

In this embodiment, the circuit board CB1 includes a circuit board frame, a flexible circuit board, or a rigid circuit board disposed in the internal space of the electronic apparatus ED1, and is not limited in the present disclosure.

In other embodiments, the antenna device AT5 can also be disposed inside the housing CE1, and is not limited in the present disclosure. In this embodiment, the electronic apparatus ED1 is a smart phone, a tablet computer, a wearable electronic apparatus or a laptop computer.

### Beneficial Effects of the Embodiments

In conclusion, the antenna device and electronic apparatus provided by the present disclosure have a simple structure and can be easily designed, and the antenna structure of the present disclosure can eliminate unnecessary resonance noises to improve antenna performance, and is manufactured using a laser direct forming process, which can effectively reduce working hours and costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna device, comprising:
an antenna structure; and
a noise suppression part being disposed at one side of the antenna structure, the noise suppression part and the antenna structure having a predetermined distance therebetween;
wherein the noise suppression part is connected to the antenna structure through a common grounding part, and the noise suppression part and the antenna structure are separately disposed.

2. The antenna device according to claim 1, wherein the antenna structure at least includes an inverted F antenna.

3. The antenna device according to claim 2, wherein the noise suppression part includes a first suppression part and a second suppression part, one terminal of the second suppression part is connected to the first suppression part, one side of the first suppression part and one side of the antenna structure have the predetermined distance therebetween, and the predetermined distance is 5 mm.

4. The antenna device according to claim 3, wherein the first suppression part is disposed at a first substrate, the second suppression part is disposed at a second substrate, and an angle is defined between the first suppression part and the second suppression part.

5. The antenna device according to claim 4, wherein the first suppression part and the second suppression part are in an L-shaped arrangement.

6. The antenna device according to claim 5, wherein the first suppression part and the second suppression part are rectangular structures.

7. The antenna device according to claim 6, wherein a distance between the second suppression part and the antenna structure is greater than or equal to the predetermined distance, the predetermined distance is 5 mm, the distance between the second suppression part and the antenna structure is 6 mm.

8. The antenna device according to claim 7, wherein a length value of the second suppression part is at least greater than or equal to 5 mm, the first suppression part includes a first suppression length value and a first suppression width value, and the first suppression length value and the second suppression width value are 8.2 mm.

9. The antenna device according to claim 5, wherein the first suppression part is a rectangular structure, the second suppression part is an L-shaped structure, the second suppression part includes a first length part and a second length part, one terminal of the first length part is connected to the first suppression part, another terminal of the first length part is connected to one terminal of the second length part, a length value of the first length part is 5 mm, and the length value of the second length part is 2 mm.

10. An electronic apparatus, comprising:
a housing;
a circuit board, being disposed in the housing; and
an antenna device, the antenna device being disposed on the housing or the circuit board;
wherein the antenna device includes:
an antenna structure; and
a noise suppression part being disposed at one side of the antenna structure, the noise suppression part and the antenna structure having a predetermined distance therebetween;
wherein the noise suppression part is connected to the antenna structure through a common grounding part, and the noise suppression part and the antenna structure are separately disposed.
